(19) United States
(12) Patent Application Publication
(10) Pub. No.: US 2015/0252731 A1
(43) Pub. Date: Sep. 10, 2015

(54) GAS TURBINE ENGINE INCLUDING BLEED SYSTEM COUPLED TO UPSTREAM AND DOWNSTREAM LOCATIONS OF COMPRESSOR

(71) Applicant: UNITED TECHNOLOGIES CORPORATION, Hartford, CT (US)

(72) Inventor: William J. Riordan, Coventry, CT (US)

(21) Appl. No.: 14/431,316

(22) PCT Filed: Feb. 22, 2013
(86) PCT No.: PCT/US13/27250

§ 371 Date: Mar. 26, 2015

Related U.S. Application Data
(60) Provisional application No. 61/708,376, filed on Oct. 1, 2012.

(51) Int. Cl. F02C 9/18; F02C 3/04

(52) U.S. Cl. CPC F02C 9/18; F02C 3/04

(57) ABSTRACT

A gas turbine engine includes a compressor section, a combustor in fluid communication with the compressor section, a turbine section in fluid communication with the combustor, and a bleed system that is configured to receive bleed air from the compressor section. The bleed system includes a first inlet duct coupled to an upstream location of the compressor section and a second inlet duct coupled to a downstream location of the compressor section. The first inlet duct and the second inlet duct merge into a common duct.

### CROSS REFERENCE TO RELATED APPLICATION

This application claims priority to U.S. Provisional Application No. 61/706,376, which was filed 1 Oct. 2012 and is incorporated herein by reference.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the low inner shaft. A direct drive gas turbine engine includes a fan section driven by the low spool such that the low pressure compressor, low pressure turbine and fan section rotate at a common speed in a common direction.

A speed reduction device such as an epicyclical gear assembly may be utilized to drive the fan section such that the fan section may rotate at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

Air can be bled from the compressor section and used for various purposes, such as for cooling of hot components and for providing conditioned air to an aircraft cabin.

### SUMMARY

A gas turbine engine according to an exemplary aspect of the present disclosure includes a compressor section, a combustor in fluid communication with the compressor section, a turbine section in fluid communication with the combustor, and a bleed system configured to receive bleed air from the compressor section. The bleed system includes a first inlet duct coupled to an upstream location of the compressor section and a second inlet duct coupled to a downstream location of the compressor section. The first inlet duct and the second inlet duct merging into a common duct.

In a further non-limiting embodiment of any of the examples herein, the second inlet duct includes a flow-control valve that is configured to selectively open and close flow from the compressor section through the second inlet duct.

In a further non-limiting embodiment of any of the foregoing examples, the first inlet duct includes a check valve.

In a further non-limiting embodiment of any of the foregoing examples, the second inlet duct includes a flow-control valve configured to selectively open and close flow from the compressor section through the second inlet duct, and the first inlet duct includes a check valve.

In a further non-limiting embodiment of any of the foregoing examples, the common duct includes a pressure-control valve.

A further non-limiting embodiment of any of the foregoing examples, a heat exchanger is arranged in receiving communication with the common duct.

In a further non-limiting embodiment of any of the foregoing examples, the heat exchanger is also arranged in receiving communication with a fan air duct and is operable to exchange heat between the fan air duct and the common duct.

In a further non-limiting embodiment of any of the foregoing examples, the common duct continues from the heat exchanger to an aircraft.

In a further non-limiting embodiment of any of the foregoing examples, the upstream location of the compressor section is a high pressure compressor stage.

In a further non-limiting embodiment of any of the foregoing examples, the upstream location is a high pressure compressor stage of the compressor section and the downstream location is a diffuser stage of the compressor section.

A bleed system according to an exemplary aspect of the present disclosure includes a first inlet duct configured to receive bleed air from an upstream location of a compressor section of a gas turbine engine, a second inlet duct configured to receive bleed air from a downstream location of the compressor section of the gas turbine engine, and a common duct into which the first inlet duct and the second inlet duct merge.

In a further non-limiting embodiment of any of the foregoing examples, the second inlet duct includes a flow-control valve that is configured to selectively open and close flow from the downstream location through the second inlet duct.

In a further non-limiting embodiment of any of the foregoing examples, the first inlet duct includes a check valve.

In a further non-limiting embodiment of any of the foregoing examples, the second inlet duct includes a flow-control valve configured to selectively open and close flow from the downstream location through the second inlet duct, and the first inlet duct includes a check valve.

In a further non-limiting embodiment of any of the foregoing examples, the common duct includes a pressure-control valve.

A method of providing bleed air from a compressor of a gas turbine engine according to an exemplary aspect of the present disclosure includes selecting between providing bleed air from an upstream location of a compressor section of a gas turbine engine and a downstream location of the compressor section of the gas turbine engine according to an engine power level of the gas turbine engine.

In a further non-limiting embodiment of any of the foregoing examples, includes selecting the upstream location in response to the engine power level being high and selecting the downstream location in response to the engine power level being low.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example gas turbine engine.

FIG. 2 illustrates an example bleed system on a compressor section of the gas turbine engine of FIG. 1.

FIG. 3 schematically illustrates a representation of the bleed system of FIG. 2.

### DETAILED DESCRIPTION

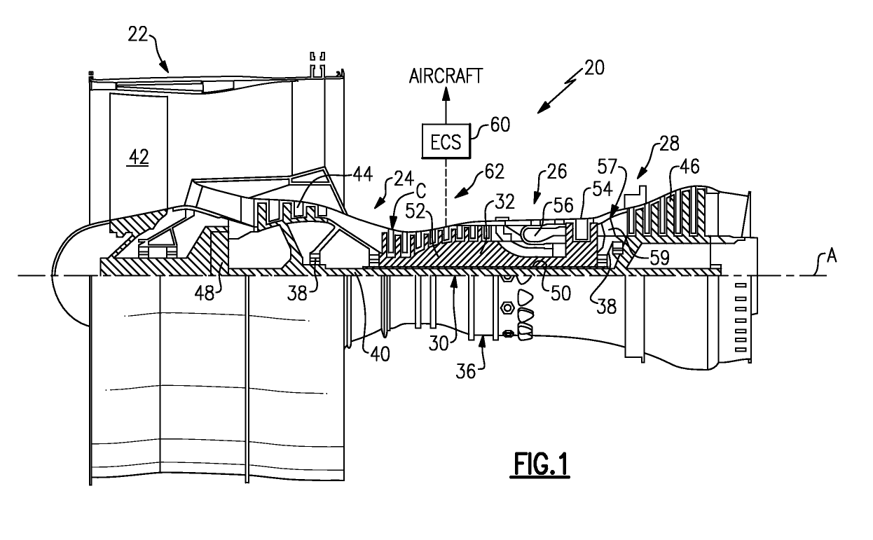

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines, including three-spool architectures and ground-based turbines.

The engine 20 generally includes a first spool 30 and a second spool 32 mounted for rotation about an engine central axis A relative to an engine static structure 36 via several bearing systems 38. It should be understood that various bearing systems 38 at various locations may alternatively or additionally be provided.

The first spool 30 generally includes a first shaft 40 that interconnects a fan 42, a first compressor 44 and a first turbine 46. The first shaft 40 is connected to the fan 42 through a gear assembly of a fan drive gear system 48 to drive the fan 42 at a lower speed than the first spool 30. The second spool 32 includes a second shaft 50 that interconnects a second compressor 52 and second turbine 54. The first spool 30 runs at a relatively lower rotational speed and hence pressure than the second spool 32. It is to be understood that “low pressure” and “high pressure” or variations thereof as used herein are relative terms indicating that the high pressure is greater than the low pressure. An annular combustor 56 is arranged between the second compressor 52 and the second turbine 54. The first shaft 40 and the second shaft 50 are concentric and rotate via bearing systems 38 about the engine central axis A which is collinear with their longitudinal axes.

The core airflow is compressed by the first compressor 44 then the second compressor 52, mixed and burned with fuel in the annular combustor 56, then expanded over the second turbine 54 and first turbine 46. The first turbine 46 and the second turbine 54 rotationally drive, respectively, the first spool 30 and the second spool 32 in response to the expansion.

The engine 20 is a high-bypass geared aircraft engine that has a bypass ratio that is greater than about six (6), with an example embodiment, being greater than ten (10), the gear assembly of the fan drive gear system 48 is an epicyclic gear train, such as a planetary gear system or other gear system, with a gear reduction ratio of greater than about 2.3:1 and the first turbine 46 has a pressure ratio that is greater than about 5. The first turbine 46 pressure ratio is pressure measured prior to inlet of first turbine 46 as related to the pressure at the outlet of the first turbine 46 prior to an exhaust nozzle. The first turbine 46 has a maximum rotor diameter and the fan 42 has a fan diameter such that a ratio of the maximum rotor diameter divided by the fan diameter is less than 0.6. It should be understood, however, that the above parameters are only exemplary.

A significant amount of thrust is provided by the bypass flow due to the high bypass ratio. The fan section 22 of the engine 20 is designed for a particular flight condition—typically cruise at about 0.8 Mach and about 35,000 feet. The flight condition of 0.8 Mach and 35,000 feet, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. To make an accurate comparison of fuel consumption between engines, fuel consumption is reduced to a common denominator, which is applicable to all types and sizes of turbojets and turbofans. The term is thrust specific fuel consumption, or TSFC. This is an engine's fuel consumption in pounds per hour divided by the net thrust. The result is the amount of fuel required to produce one pound of thrust. The TSFC unit is pounds per hour per pounds of thrust (lb/hr/lb Fn). When it is obvious that the reference is to a turbojet or turbofan engine, TSFC is often simply called specific fuel consumption, or SFC. “Low fan pressure ratio” is the pressure ratio across the fan blade alone, without a Fan Exit Guide Vane system. The low fan pressure ratio as disclosed herein according to one non-limiting embodiment is less than about 1.5. “Low corrected fan tip speed” is the actual fan tip speed in feet per second divided by an industry standard temperature correction of [(Tram ° R)/(518.7 ° R)]^{0.5}. The “Low corrected fan tip speed” as disclosed herein according to one non-limiting embodiment is less than about 1150 feet per second.

The engine 20 provides pressurized air to an environmental control system 60 through a bleed system 62 for aircraft cabin pressurization and aircraft wing de-icing. Size constraints of a geared turbofan engine core compartment, such as compartment C, present design challenges in order to meet customer requirements.

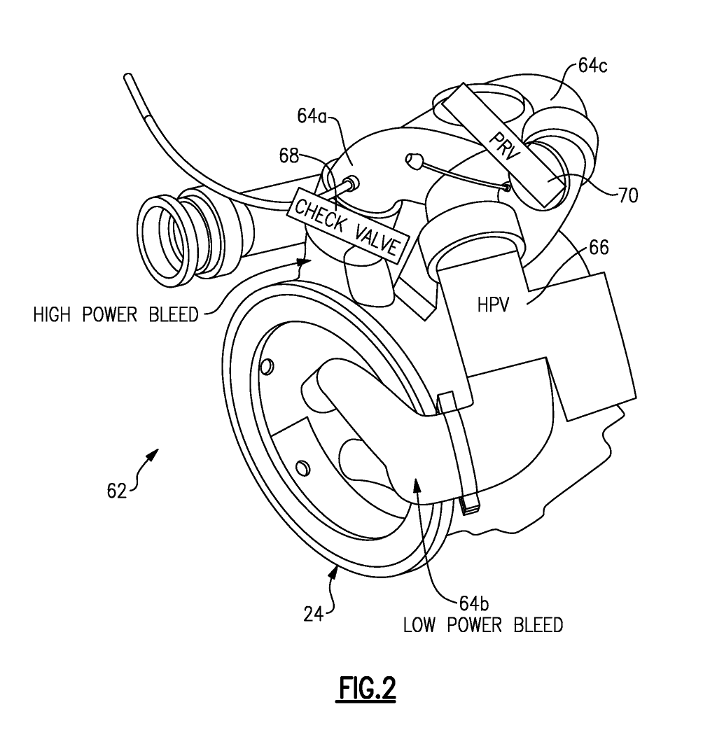

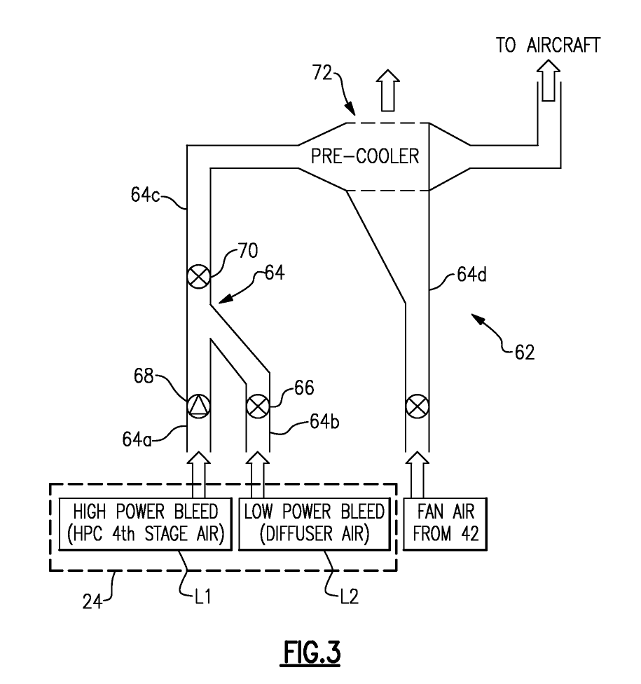

FIG. 2 shows a perspective view of the bleed system 62 and FIG. 3 shows a schematic view of the bleed system 62. The bleed system 62 is operable to convey pressurized air from the engine 20 to an aircraft on which the engine is used. The system 62 includes ducting 64 to convey pressurized air from the engine 20. In this example, the bleed system 62 includes a first inlet duct 64a connected with a first axial location L1 of the compressor section 24 and a second inlet duct 64b connected with a second, different axial location L2 of the compressor section 24. Different air pressures are provided at the different axial locations L1/L2. As can be appreciated, the bleed system 62 can further include additional inlet ducts at additional axial locations.

In a further example, the first inlet duct 64a is connected at a port at the first axial location L1 with a high pressure stage, and the second inlet duct 64b is connected at a port at the second axial location L2 with a diffuser stage of the compressor section 24. For example, the high pressure compressor stage is the fourth stage. The inlet ducts 64a/64b merge into a common duct 64c that leads to the aircraft.

A flow-control valve 66, known as a high pressure valve (HPV), is located in the second inlet duct 64b and controls which of the inlet ducts 64a/64b are actively providing compressed air in the bleed system 62. For example, at low engine power, the valve 66 opens to allow diffuser stage air into the bleed system 62, as this air is at a sufficient pressure to meet a given system requirement. A check valve 68 in the first inlet duct 64a prevents the diffuser air from flowing into the first axial location L1 of the compressor section 24. At Low power, the upstream pressure at axial location L1 is not sufficient to meet the bleed system requirements, and the flow-control valve 66 in the downstream (higher pressure) duct at axial location L2 opens to allow the higher pressure bleed air to flow into the common duct and to the aircraft. The check valve 68 is in the upstream section and is closed such that the higher pressure air does not flow back into the compressor at the upstream location. At high engine power settings, there is sufficient pressure at the upstream location at axial location L1 and the flow-control valve 66 closes, shutting off the higher pressure location and allowing the upstream location to flow to the aircraft.

Overall pressure in the bleed system 62 is regulated by a pressure regulating valve (PRV) 70 in the common duct 64c. At high engine power, there is sufficient pressure at the first axial location L1 to meet the given system requirement, for example. The flow-control valve 66 shuts, to allow air from the first axial location L1 into the first inlet duct 64a at the high engine power.

A heat exchanger 72 is located downstream of the PRV 70. The heat exchanger 72 serves as a pre-cooler, which receives fan air from the bypass flowpath through fan air duct 64d when needed to cool the bleed air from the compressor section 24 in the ECS 60 before the bleed air flows to the aircraft.

The bleed system 62 allows the engine 20 to provide pressurized air to the aircraft for cabin pressurization/air conditioning as well as aircraft wing de-icing. The bleed system 62 also can meet the unique size, weight, and performance requirements of the engine 20.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A gas turbine engine comprising:
a compressor section;
a combustor in fluid communication with the compressor section;
a turbine section in fluid communication with the combustor; and
a bleed system configured to receive bleed air from the compressor section, the bleed system including a first inlet duct coupled to an upstream location of the compressor section and a second inlet duct coupled to a downstream location of the compressor section, the first inlet duct and the second inlet duct merging into a common duct.

2. The gas turbine engine as recited in claim 1, wherein the second inlet duct includes a flow-control valve that is configured to selectively open and close flow from the compressor section through the second inlet duct.

3. The gas turbine engine as recited in claim 1, wherein the first inlet duct includes a check valve.

4. The gas turbine engine as recited in claim 1, wherein the second inlet duct includes a flow-control valve configured to selectively open and close flow from the compressor section through the second inlet duct, and the first inlet duct includes a check valve.

5. The gas turbine engine as recited in claim 4, wherein the common duct includes a pressure-control valve.

6. The gas turbine engine as recited in claim 1, further comprising a heat exchanger arranged in receiving communication with the common duct.

7. The gas turbine engine as recited in claim 6, wherein the heat exchanger is also arranged in receiving communication with a fan air duct and is operable to exchange heat between the fan air duct and the common duct.

8. The gas turbine engine as recited in claim 7, wherein the common duct continues from the heat exchanger to an aircraft.

9. The gas turbine engine as recited in claim 1, wherein the upstream location of the compressor section is a high pressure compressor stage.

10. The gas turbine engine as recited in claim 1, wherein the upstream location is a high pressure compressor stage of the compressor section and the downstream location is a diffuser stage of the compressor section.

11. A bleed system comprising:
a first inlet duct configured to receive bleed air from an upstream location of a compressor section of a gas turbine engine;
a second inlet duct configured to receive bleed air from a downstream location of the compressor section of the gas turbine engine; and
a common duct into which the first inlet duct and the second inlet duct merge.

12. The bleed system as recited in claim 11, wherein the second inlet duct includes a flow-control valve that is configured to selectively open and close flow from the downstream location through the second inlet duct.

13. The bleed system as recited in claim 11, wherein the firstinlet duct includes a check valve.

14. The bleed system as recited in claim 11, wherein the second inlet duct includes a flow-control valve configured to selectively open and close flow from the downstream location through the second inlet duct, and the first inlet duct includes a check valve.

15. The bleed system as recited in claim 14, wherein the common duct includes a pressure-control valve.

16. A method of providing bleed air from a compressor of a gas turbine engine, the method comprising:
selecting between providing bleed air from an upstream location of a compressor section of a gas turbine engine and a downstream location of the compressor section of the gas turbine engine according to an engine power level of the gas turbine engine.

17. The method as recited in claim 16, including selecting the upstream location in response to the engine power level being high and selecting the downstream location in response to the engine power level being low.
